(19) United States
(12) Patent Application Publication
(10) Pub. No.: US 2026/0266589 A1
(43) Pub. Date: Sep. 10, 2026

(54) OPTICAL DEVICE FOR PROJECTING A PATTERN ONTO A SURFACE

(71) Applicants: Carl Zeiss AG, Oberkochen (DE); Printoptix GmbH, Stuttgart (DE)

(72) Inventors: Soeren Schmidt, Jena (DE); Simon Thiele, Stuttgart (DE); Marco Hanft, Jena (DE); Alois Herkommer, Stuttgart (DE); Manuel Decker, Jena (DE); Valese Aslani, Stuttgart (DE)

(73) Assignees: Carl Zeiss AG, Oberkochen (DE); Printoptix GmbH, Stuttgart (DE)

(21) Appl. No.: 19/491,420

(22) PCT Filed: Jun. 12, 2024
(86) PCT No.: PCT/EP2024/066289

§ 371 Date: Dec. 9, 2025

(30) Foreign Application Priority Data
Jun. 14, 2023 (DE) 10 2023 115 518.0

(51) Int. Cl. G01B 9/08; B33Y 80/00; G01B 11/25; G03B 21/00

(52) U.S. Cl. CPC G01B 9/08; B33Y 80/00; G01B 11/254; G03B 21/001

(57) ABSTRACT

An optical device for projecting a pattern onto a surface has a slide, wherein the slide, for generating the pattern, refracts and/or diffracts and/or reflects and/or absorbs some of the light radiated into the optical device, and a projection optical unit, wherein the projection optical unit is designed to image the pattern onto the surface, wherein the slide and the projection optical unit are designed in a single piece.

### PRIOR ART

In hard-to-reach cavities, the flatness of a surface can be detected by means of a pattern projected onto the surface by light. For this purpose, light is radiated onto the surface by e.g. an endoscope, and the projected pattern is captured optically.

A slide can be used to generate the pattern, and a projection optics unit images the pattern onto the surface.

A disadvantage of such devices or methods known to date is that the projection optics unit must be aligned with the slide. In addition, the orientation or alignment between the slide and the projection optics unit may change over time, changing the pattern.

### DISCLOSURE OF THE INVENTION

The problem addressed by the invention is that of revealing an optics device for projecting a pattern on a surface, the optics device being technically particularly simple and the relative spatial position between a slide of the optics device and a projection optics unit of the optics device remaining reliably unchanged therein.

This problem is solved by an optics device as claimed in claim 1 for projecting a pattern onto a surface.

In particular, the problem is solved by an optics device for projecting a pattern onto a surface, the optics device comprising the following: a slide, the slide refracting and/or diffracting and/or reflecting and/or absorbing some of the light radiated into the optics device in order to generate the pattern, and a projection optics unit, the projection optics unit being designed to image the pattern onto the surface, characterized in that the slide and the projection optics unit are formed in one piece.

An advantage thereof is that the optics device is constructed very simply from a technical point of view. Moreover, the alignment between the slide and the projection optics unit cannot change as these are formed in one piece and thus spatially unalterable to each other. Hence, the optics device can project the pattern in reliably unchanged and precise fashion. Moreover, the optics device can be used with incoherent light. This avoids speckle effects. In particular, a multimodal light source with a large spectral bandwidth can be used to radiate the light into the optics device. A further advantage is that the optics device can generate a locally varying intensity distribution and/or angular distribution. In this way, extraneous light, i.e. unwanted light, can be prevented from contributing to the projected pattern. Portions of the light that are not intended to contribute to the projected pattern may be prevented by way of refraction, diffraction, reflection, and/or absorption from reaching the surface on which the pattern should be projected. The optics device may be produced by way of an additive manufacturing method, in particular in one piece.

The invention also addresses the problem of revealing a light projection device with a very simple construction from a technical point of view.

In particular, this problem is solved by a light projection device comprising an optics device as described above and a light source for transmitting light into the optics device, wherein the optics device is arranged on the light source in such a way that due to refraction and/or diffraction and/or reflection and/or absorption in the slide, the light emitted by the light source, only some of the light emitted by the light source forms the pattern projected by the optics device.

What is advantageous about this is that the light projection device has a very simple construction from a technical point of view. In addition, in the light projection device, the alignment between the slide and the projection optics unit relative to each other is unalterable. Since the light from the light source is refracted, diffracted, reflected and/or absorbed by the slide, the light source can radiate incoherent light into the optics device. This prevents speckle effects.

A further problem addressed by the invention is that of revealing a method for producing an optics device, by means of which an optics device can be produced easily from a technical point of view.

In particular, the problem is solved by a method for producing an optics device, in particular as described above, in an additive manufacturing method, wherein the method comprises the following steps: producing a slide, the slide refracting and/or diffracting and/or reflecting and/or absorbing some of the light radiated into the optics device in order to generate a pattern on a surface, and a projection optics unit, the projection optics unit being designed to image the pattern onto a surface, wherein the slide and the projection optics unit are produced in one piece.

One advantage thereof is that the slide and the projection optics unit can be produced using the same additive manufacturing method. In addition, this type of production ensures the fixed or constant alignment or positioning of the projection optics unit relative to the slide or vice versa. A displacement, an alignment assembly error or the like cannot occur. Moreover, (temporally and/or spatially) incoherent light can be used in the optics device produced by this method. The speckle effect can be avoided in this way. Moreover, extraneous light, i.e. unwanted light, can be reliably prevented by the produced optics device from contributing to the projected pattern or negatively affecting the latter (e.g. by virtue of dark regions of the pattern being illuminated by the extraneous light). For example, this can be implemented by virtue of steering the extraneous light within the optics unit to light traps or absorbing regions. The additive manufacturing method can be a 3D printing method in particular.

The invention furthermore addresses the problem of revealing a method for examining a surface, by means of which the properties of the surface can be detected in technically simple and reliable fashion, even in regions that are hard to reach.

This problem is solved by a method for examining a surface, as claimed in claim 17.

In particular, the problem is solved by a method for examining a surface, the method comprising the following steps: radiating light through an optics device as described above or from a light projection device as described above or through an optics device produced by means of a method as described above, in order to generate a pattern, in particular an at least partially regular pattern, on the surface; capturing the light reflected from the surface; and comparing the reflected light with a target pattern, in particular by means of a machine learning system, in order to determine properties, in particular unevenness, of the surface.

An advantage thereof is that the method is technically simple, and incoherent light can be used. The speckle effect can be avoided as a result. Moreover, the method can be performed reliably and precisely, since the position of the projection optics unit relative to the slide cannot change, and hence the position and/or shape of the projected pattern cannot change (on account of a change in the relative position of the slide with respect to the projection optics unit). In addition, the method allows particularly compact geometries, as the one-piece embodiment eliminates the need for guide or alignment structures.

According to an embodiment of the optics device, the slide is designed such that the slide is substantially completely transmissive to the light directed at the slide. An advantage thereof is that all of the light can be used to generate the pattern. Hence, the amount of light required is particularly small, and hence the pattern can be projected onto the surface with a particularly high contrast. Also, no light is absorbed by the slide in the process. All of the light or some of the light can contribute to generating the pattern. Deflected, refracted and/or diffracted and/or reflected light can emanate from the slide in such a way that it does not contribute to generating the pattern. All of the light radiates through the slide in refracted and/or diffracted and/or reflected fashion.

According to an embodiment of the optics device, the slide and the projection optics unit are made of substantially the same material, in particular substantially the same dielectric material. What is advantageous about this is that the optics device has an even simpler construction from a technical point of view. In addition, the optics device can be produced very easily from a technical point of view. The material can be the same in each case. By preference, the material may comprise or be an acrylate-based photopolymer, for example polymethylmethacrylate (PMMA).

According to an embodiment of the optics device, the slide is designed in such a way that some the light directed at the slide is refracted and/or diffracted and/or reflected by the slide in such a way that the refracted and/or diffracted and/or reflected portion of the light radiation is not incident on the projection optics unit. An advantage thereof is that unwanted light is not radiated from the optics device in the direction of the surface or the projected pattern. This can reliably prevent the refracted and/or diffracted and/or reflected portion of the light from being incident on the surface, as it does not even reach the projection optics unit. Hence, the contrast of the pattern can be particularly high, or a high contrast of the pattern can be obtained even with little light.

According to an embodiment of the optics device, the projection optics unit comprises two lenses, in particular two aspherical lenses, that are spaced apart from each other. The advantage thereof is that the focus of the projection optics unit can be set particularly easily during production, and the projection is particularly distortion-free and generally has fewer aberrations. The optics device may comprise more than two lenses, in particular more than two aspherical lenses, that are spaced apart from one another.

According to an embodiment of the optics device, the slide and the projection optics unit are connected, in particular directly connected, to each other by way of multiple first connecting pieces, with the connecting pieces being formed in one piece with the slide and the projection optics unit. An advantage thereof is that the position of the slide relative to the projection optics unit is particularly stable from a mechanical point of view. Hence, the optics device is very robust vis-à-vis mechanical influences. The connecting pieces can connect the slide and the projection optics unit to each other immediately or directly, i.e. no further elements apart from the first connecting pieces are present on the connecting path from the slide to the projection optics unit.

According to an embodiment of the optics device, the slide is designed such that at least a first region of the slide refracts and/or diffracts and/or reflects and/or absorbs light of different wavelengths differently. An advantage thereof is that different patterns can be projected by means of the same slide by using light of different wavelengths. Hence it is conceivable that by using the same slide, a first pattern (e.g. a stripe pattern with horizontal stripes) can be projected by means of yellow light and a second pattern (e.g. a stripe pattern with vertical stripes and/or a pattern with one or more circles), which differs from the first pattern, can be projected by means of red light. This allows the surface to be examined even more closely. According to an embodiment of the optics device, the slide is designed such that the projected pattern has at least one region with a gray tone when the optics device is irradiated by white light. An advantage thereof is that not only white and black regions of the pattern can be produced by white light, but regions of the pattern that have a gray tone or different gray tones can also be projected. Hence, even with white light, the pattern can have more than two colors (where black and white are counted as colors), for example black, gray and white.

According to an embodiment of the light projection device, the optics device is arranged on the light source in such a way that due to refraction and/or diffraction and/or reflection and/or absorption in the slide, only some of the light emitted by the light source passes through the optics device. An advantage thereof is that unwanted light does not leave the optics device. This ensures that this light does not contribute to the pattern or negatively affect the pattern. What is moreover achieved thereby is that the light projection device projects a pattern that has a high contrast even in low light.

According to an embodiment of the light projection device, the light source comprises an optical fiber, in particular a multimodal optical fiber, a waveguide and/or an LED. What is advantageous about this is that the light projection device has a very simple construction from a technical point of view and is cost-effective. In addition, the light projection device can have a particularly compact embodiment.

According to an embodiment of the light projection device, the light source is formed in one piece with the optics device. An advantage thereof is that the light projection device can be produced very easily from a technical point of view. Moreover, slipping/shifting of the optics device relative to the light source and/or detachment of the optics device from the light source is reliably prevented. This ensures that the light from the light source is always radiated into the optics device at the same angle.

According to an embodiment of the light projection device, the light source is designed in such a way that the light source radiates light onto the optics device in a conical shape, in particular a circular conical shape, with an opening angle of no more than 30°, in particular of no more than 15° and preferably of no more than 5°. This allows a particularly detailed pattern to be projected. Hence, the surface can be examined in particular detail by means of the light projection device.

According to an embodiment of the method for producing an optics device, the optics device is produced additively directly on a light source for radiating light into the optics device. An advantage thereof is that the optics device cannot change its relative position vis-à-vis the light source. In particular, detachment of the optics device from the light source is also reliably prevented. In addition, this manufacturing method ensures that the light source always radiates the light into the optics device at the same angle. Moreover, the manufacturing method is particularly straightforward in technical terms.

According to an embodiment of the method for producing an optics device, the slide is produced in such a way that only some of the light radiated into the optics device reaches the projection optics unit. An advantage thereof is that unwanted light reliably does not adversely affect the projected pattern. As a result of some of the light, specifically the unwanted portion, not reaching the projection optics unit, the pattern is reliably not affected by this portion of the light. Consequently, a particularly high contrast of the pattern is achievable.

By way of example, the refraction, diffraction, reflection and/or absorption by the slide of the light radiated into the optics device can be performed by the following measures: refractive deflection by the slide; deflection by total-internal reflection within the slide; generation of a point array or intermediate image by means of a lens structure of the slide, with the point array being spaced apart from the slide; reflection on the basis of a Fabry-Perot resonator structure; deflection by a grating of the slide; absorption by absorbent materials of the slide; and/or absorption by fluids, in particular liquids, introduced into the slide after the production of the optics device.

In particular, a pattern may be understood to mean a structure that is at least partly regular. The pattern typically comprises simple geometric figures or structures (e.g. straight lines, circles, etc.). For example, the pattern may be a stripe pattern and/or a pattern with ellipses and/or circles. The pattern may consist in particular of brighter and darker regions (i.e. regions illuminated faintly by the light or not at all). In particular, these regions may alternate regularly within the pattern. The pattern need not necessarily comprise repetitive structures but may for example only comprise a single geometric shape (for example, a circle, an ellipse, a rectangle and/or a triangle). The pattern may comprise repetitive structures (for example, a stripe pattern). For example, the pattern may also consist of a pixelated arrangement of gray values that together result in an image.

In particular, the projection optics unit may comprise one lens or multiple lenses. The projection optics unit may focus the light or image the pattern onto the surface. The location of the focus or image may be the surface of the material whose properties should be detected or may be in front of or behind said surface of the material.

The shape of the pattern or projected pattern is known or can be easily determined. By comparing the visible pattern on the surface to what the pattern should look like on a target surface (target pattern)—for example, in the case of a flat face of the surface that runs parallel to the slide or to one of the lenses, the projected pattern should correspond exactly to the target pattern—the properties of the surface can be easily determined. Distortions, displacements or the like of the projected pattern or of a portion thereof on the surface allow conclusions to be drawn or determinations to be made about the shape and/or alignment of the surface. Thus, the projected pattern or target pattern can be a e.g. circle. If this pattern in the form of a circle is distorted into an ellipse on the surface, or an ellipse is visible on the surface, then the surface is tilted relative to a parallel to the slide or lens, or the surface has an angle not equal to zero to the parallel to the slide or lens.

In particular, the slide may have three-dimensional slide structural elements, by which the light is partially refracted and/or diffracted and/or reflected and/or absorbed and through which some of the light is passed substantially unchanged and substantially unchanged in terms of its direction of propagation.

Preferred embodiments will emerge from the dependent claims. The invention is explained in greater detail below with reference to drawings of exemplary embodiments. In the figures:

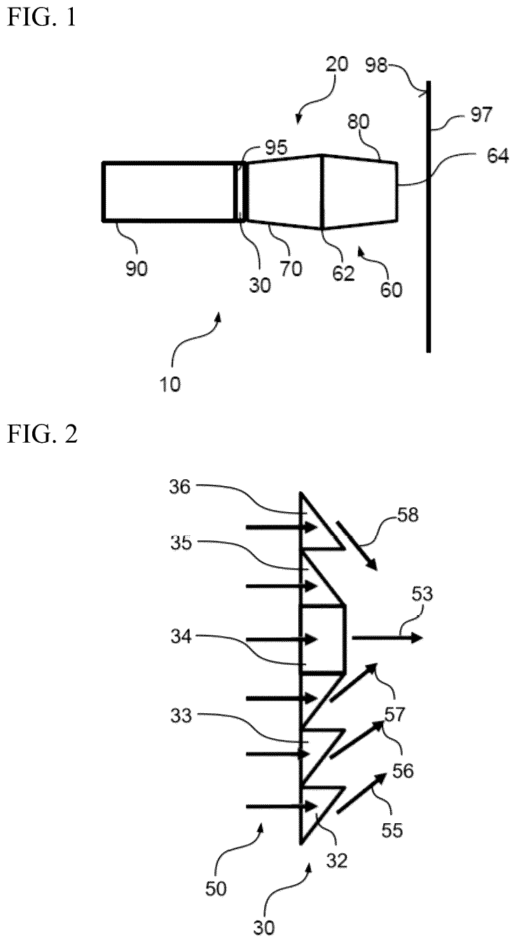

FIG. 1 shows a schematic side view of an embodiment of the light projection device according to the invention;

FIG. 2 shows a detailed view of a first embodiment of the slide of the light projection device from FIG. 1;

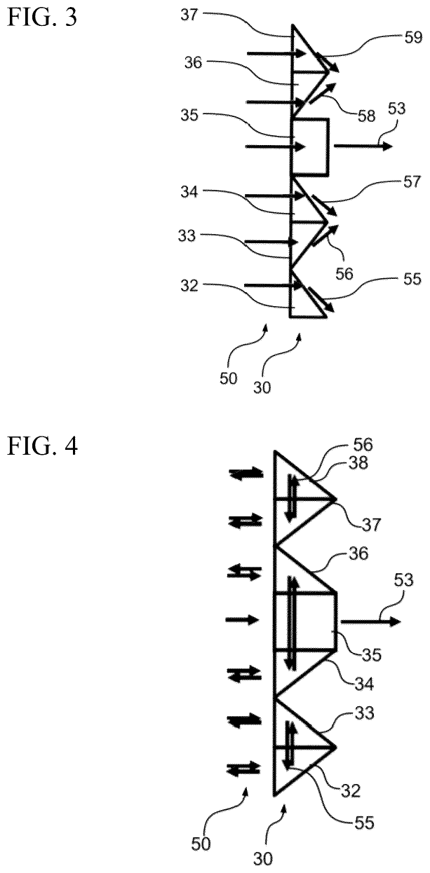

FIG. 3 shows a detailed view of a second embodiment of the slide of the light projection device from FIG. 1;

FIG. 4 shows a detailed view of a third embodiment of the slide of the light projection device from FIG. 1;

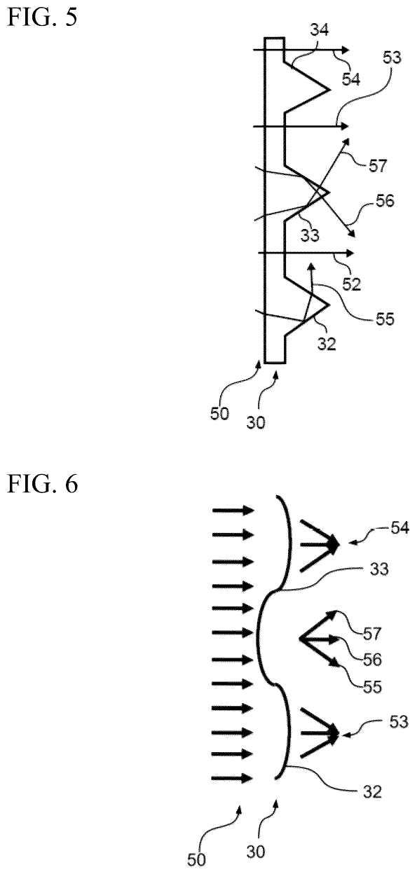

FIG. 5 shows a detailed view of a fourth embodiment of the slide of the light projection device from FIG. 1;

FIG. 6 shows a detailed view of a fifth embodiment of the slide of the light projection device from FIG. 1;

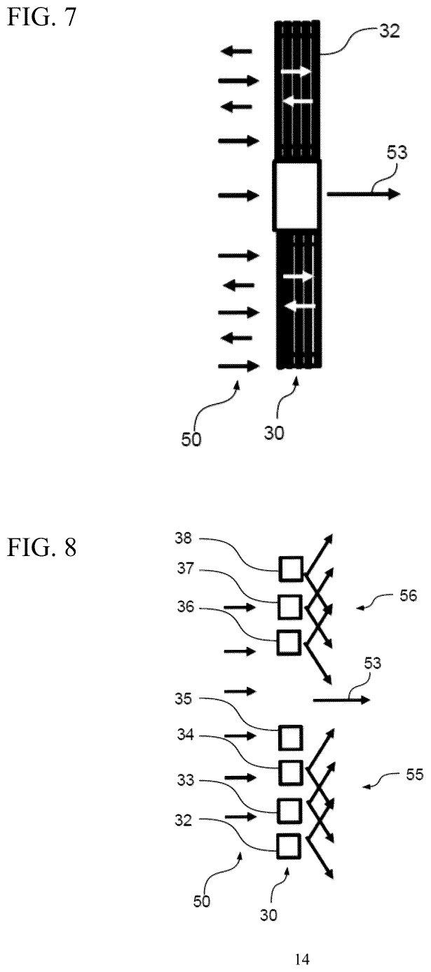

FIG. 7 shows a detailed view of a sixth embodiment of the slide of the light projection device from FIG. 1;

FIG. 8 shows a detailed view of a seventh embodiment of the slide of the light projection device from FIG. 1;

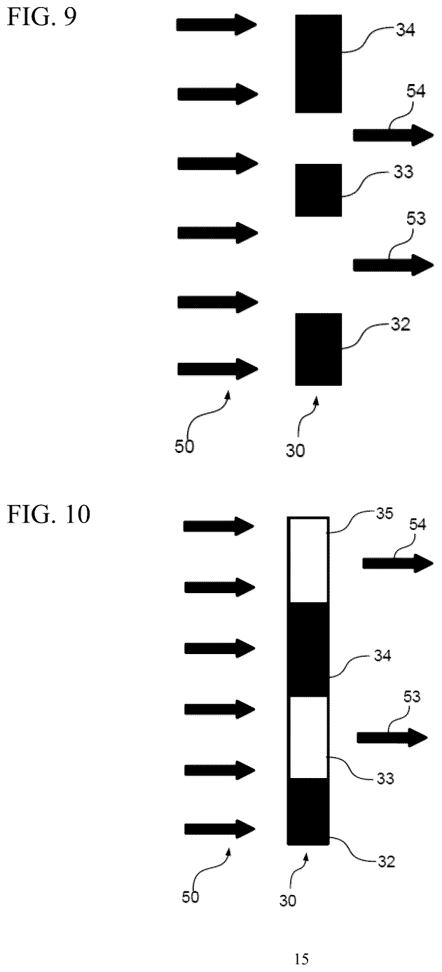

FIG. 9 shows a detailed view of an eighth embodiment of the slide of the light projection device from FIG. 1; and

FIG. 10 shows a detailed view of a ninth embodiment of the slide of the light projection device from FIG. 1.

The same reference signs are used in the following description for parts that are the same and parts that act in the same way.

FIG. 1 shows a schematic side view of an embodiment of the light projection device 10 according to the invention.

The light projection device 10 is designed to project a pattern onto a surface 98 of a material 97. The light projection device 10 comprises a light source and an optics device 20. The light source may generate the light itself (e.g. LED) or guide the light from a light generating device and represent a light source in this way.

The light source may comprise an optical fiber 90, in particular a multimodal optical fiber, a waveguide and/or an LED. The light may be (temporally or spatially) incoherent light. The light source, e.g. the optical fiber 90, may have a small diameter (e.g. less than 500 μm). A broad spectrum of wavelengths can be used. This prevents a speckle effect. For example, the light projection device 10 or the optics device 20 of the light projection device 10 may be arranged on or in a photonic integrated circuit (PIC) or be a part thereof.

It is conceivable that the optics device 20 is formed in one piece with the light source. Hence, the optics device 20 is immovable with respect to the light source.

The optics device 20 comprises a slide 30 and a projection optics unit 60. The light from the light source is radiated into the optics device 20 from said light source. By means of the light, the optics device 20 projects a pattern onto a surface 98 of a material 97. The pattern or the pattern visible on the surface 98 can be captured optically.

The slide 30 generates a locally varying intensity or angle distribution. Thereby, the slide 30 generates the pattern, and the projection optics unit 60 focuses the beams of the pattern or the pattern and/or images the pattern onto the surface.

The slide 30 may in particular have a circular disk-shaped form.

The optics device 20 is produced in one piece by means of an additive manufacturing method. The slide 30 and the projection optics unit 60 are produced by the same additive manufacturing method. This means that the slide 30 and the projection optics unit 60 have been formed in a joint or a single production method or process. Thus, no alignment or orientation of the slide 30 relative to the projection optics unit 60 is required post production. Slippage or displacement relative to each other is not possible either. The distance between the slide 30 and the projection optics unit 60 cannot change either. Hence, the shape of the pattern cannot change on account of a change in the position of the projection optics unit 60 vis-à-vis the slide 30.

The projection optics unit 60 may comprise one or more lenses 62, 64. For example, the projection optics unit 60 comprises two lenses 62, 64, in particular two aspherical lenses. The projection optics unit 60 may extend over the entire width or the entire diameter of the slide 30 or have a width or a diameter that is even larger than the slide 30.

The slide 30 and the projection optics unit 60 or the lens 62, 64 or lenses 62, 64 of the projection optics unit 60 may be produced from or consist of the same material, in particular a dielectric material. This simplifies the manufacturing method by way of an additive manufacturing process.

The slide 30 is connected to the projection optics unit 60 via multiple connecting pieces 70, 80. The slide 30 may be connected directly or immediately to the projection optics unit 60 via multiple connecting pieces 70, 80. This means that the slide 30 is not arranged on a substrate or the like, with the substrate being connected to the projection optics unit 60, but that the slide 30 is directly or immediately connected (without detours or further intermediate elements) to the connecting pieces 70, 80, and the connecting pieces 70, 80 are connected directly (without detours or further intermediate elements) to the projection optics unit 60.

First connecting pieces 70 are arranged between the slide 30 and a first lens 62 of the projection optics unit 60. Second connecting pieces 80 may be arranged between the first lens 62 and the second lens 64. The connecting pieces 70, 80 have been produced in the same additive manufacturing method in which the slide 30 and the projection optics unit 60 were produced. Hence, the slide 30, the projection optics unit 60 and the connecting pieces 70, 80 are formed in one piece or produced in one piece in an additive manufacturing method. As a result, the optics device 20 is particularly robust against mechanical influences. The slide 30 comprises multiple slide structural elements 32-38. The slide structural elements 32-38 are located on the side of the slide 30 facing the projection optics unit 60.

This means that the slide 30 can be flat on the side assigned to the light source, but it is not flat on the side assigned to the projection optics unit 60 and has instead an uneven or non-flat structure on account of the slide structure elements 32-38. The slide structural elements 32-38 refract and/or diffract and/or reflect and/or absorb the light or some of the light and/or deflect the light or some of the light.

It is possible that the slide 30 does not comprise any absorbing slide structural elements 32-38. This means that no portion of the light is absorbed by the slide 30. In this case, the light will only be refracted and/or diffracted and/or reflected.

The additive manufacturing method may comprise a 3D printing method, e.g. multi-jet fusion, fused layer modeling, free-beam material application methods, such as poly-jet modelling or multi-jet modelling, laser sintering, laser beam melting, electron beam melting, digital light processing, stereolithography and/or two-photon lithography.

FIG. 2 shows a detailed view of a first embodiment of the slide 30 of the light projection device 10 from FIG. 1. The slide structural elements 32-38 comprise multiple elements triangular in cross section, said elements making an angle to the output surface 95 of the light source and deflecting the light refractively, and multiple elements rectangular in cross section, with the surfaces of these elements that face away from the light source extending parallel to the output surface 95 of the light source and allowing the light to pass through substantially unimpeded and unchanged in its direction of propagation. The slide structural elements 32, 33, 35, 36 triangular in cross section may have a tetrahedral shape. The slide structural element(s) 34 rectangular in cross section may have a cuboid shape and/or a cube shape. The slide 30 or the side of the slide 30 that faces the light source extends parallel to the output surface 95 of the light source.

In FIG. 2, incident light 50 enters the slide 30 from the left. As a result, light that projects the pattern or is projected by means of the projection optics unit 60 (also called used light 52, 53, 54) emerges from the slide 30 and is represented by a horizontally rightward extending arrow in the upper part of FIG. 2. Moreover, some of the light is deflected by the slide 30 (represented by arrows pointing top right or bottom right in FIG. 2). This deflected light (also called extraneous light 55-59) is not projected onto the surface 98. It is possible that this deflected light does not reach the projection optics unit 60 or does not reach the surface 98 of the material 97, at least not directly (i.e. at least not without renewed reflection and/or renewed refraction and/or diffraction), from the projection optics unit 60.

Thus, a first portion of the light passes through the slide 30 substantially unchanged and unchanged in terms of its direction. This first portion of the light is focused by the projection optics unit 60 in order to form the pattern on the surface 98, or this first portion of the light is radiated by the projection optics unit 60 in order to image the pattern on the surface 98. A second portion of the light is refracted, diffracted, absorbed and/or reflected by the slide 30 in such a way that either this second portion does not reach the projection optics unit 60 or this second portion is not imaged and/or focused by the projection optics unit 60 in order to form the pattern. The second portion of the light thus does not reach the region of the surface 98 of the pattern on which the pattern is projected.

For example, the light projection device 10 may be inserted into an opening of a small diameter depression, for example to examine the surface 98 at the end of the depression. To this end, the pattern is radiated onto the surface 98 at the end of the depression by means of the light projection device 10. The reflected light from the surface 98 is captured by means of an optical capturing device. The visible pattern or visible reflected light on the surface 98 can be compared with the radiated pattern. This may be performed either by a person or by a computer or software (e.g. a machine learning system). In this way, the unevenness of the surface 98 can be identified or determined. Additionally, a tilt of the surface 98 relative to a parallel to a lens 62, 64 or the slide 30 of the projection optics unit 60 can be determined.

In this way, a pattern can be generated in technically simple fashion. The projection optics unit 60 focuses the light that reaches the projection optics unit 60 or images the pattern onto the surface 98. The focus may be located on the surface 98 of the material 97. It is also conceivable that the focus is located between the projection optics unit 60 and the surface 98 of the material 97, i.e. in front of the surface 98. It is also possible that the focus is located behind the surface 98 of the material 97.

The projection optics unit 60 is shown neither in FIG. 2 nor in the following FIGS. 3-10. In FIGS. 2-10, the projection optics unit 60 is located to the right of the slide 30 shown. The light source is situated to the left of the slide 30 in FIGS. 2-10 or may be situated to the left of the slide 30 in FIGS. 2-10.

Each of FIGS. 2-10 might show only a portion or a section of the slide 30. This means that there may be multiple regions through which the light is transmitted substantially unchanged and not only one region, as partially illustrated in FIGS. 2-10. This also means that the number of slide structural elements 32-38 is greater, in particular much greater, than what is shown in each of FIGS. 2-10. The number of slide structural elements 32-38 may be in the order of hundreds, thousands, tens of thousands, hundreds of thousands or millions.

The light that emerges from the slide 30 and contributes to the pattern or is intended to contribute is also called used light 52, 53, 54. The light that emerges (in refracted, diffracted, reflected fashion) from the slide and does not contribute to the pattern or is not intended to contribute is also referred to as extraneous light 55-59.

The slide structural elements 32-38 are produced by the additive manufacturing method (together with the projection optics unit 60). The slide structural elements 32-38 of the slide 30 generate the pattern, which radiates through the projection optics unit 60 in a manner focused on the surface 98 of the material 97 or which is imaged onto the surface 98 by the projection optics unit 60. Of course, the pattern generated by the slide 30 may be modified by the projection optics unit 60, or the pattern might only be created by the projection optics unit 60.

The pattern visible on the surface 98 of the material 97 may be captured optically. The properties of the surface 98 of the material 97 can be detected by a comparison of a target pattern (e.g. the projected pattern on a flat surface extending parallel to the output surface 95 of the light source) with the optically captured visible pattern on the surface 98. The optical capture may be performed e.g. with an endoscopic camera.

The properties of the surface 98 may be unevenness or elevations and/or depressions on the surface 98 in particular. An angle that the surface 98 makes to the parallel of the output surface 95 of the light source may also be determined thereby. The comparison may be performed by means of a computer or software. A machine learning system can also be used in the process.

The pattern may comprise a stripe pattern and/or one or more circles and/or one or more rectangles. The pattern may be static in particular.

The slide 30 or the slide structural elements 32-38 may be produced additively directly or immediately on the light source or on the output surface 95 of the light source, e.g. by 3D printing. Hence, the slide 30, the projection optics unit 60 and the light source are produced in one piece.

Each slide 30 comprises a projection optics unit 60, and vice versa. This means that each projection optics unit 60 is assigned exactly one slide 30, and that each slide 30 is assigned exactly one projection optics unit 60. The slide 30 is thus formed in one piece with exactly one projection optics unit 60, and the projection optics unit 60 is formed in one piece with exactly one slide 30. It is possible that an optics device 20 comprises exactly one slide 30 and exactly one projection optics unit 60.

The first embodiment of slide 30 allows all the radiated-in light to pass. It only partially changes the direction of the light.

FIG. 3 shows a detailed view of a second embodiment of the slide 30 of the light projection device 10 from FIG. 1.

The second embodiment differs from the first embodiment of slide 30 in that, in the second embodiment and in contrast to the first embodiment of slide 30, the slide structural element 32-38 that allows the light to pass through in substantially non-deflected fashion is arranged at a distance from deflecting elements (triangular elements in cross section) on the side that faces away from the output surface 95 of the light source (in FIG. 3 right). A slide structural element 32-38 that the light passes through substantially unchanged is arranged in the middle of the slide 30.

The second embodiment of slide 30 also allows the light, which is radiated from the light source into the slide 30, to pass completely through, or said embodiment is transmissive to the light. Only the direction of a portion of the light is changed.

FIG. 4 shows a detailed view of a third embodiment of the slide 30 of the light projection device 10 from FIG. 1.

The third embodiment differs from the first embodiment in that, in the third embodiment, the slide structural elements 32-38 (triangular in cross section) that deflect the light make a different angle to the output surface 95 of the light source in comparison with the case of the first embodiment such that the light is deflected multiple times, whereby total-internal reflection occurs. The slide structural element 32-38 (rectangular in cross section) in FIG. 4, shown in FIG. 4 in the center, allows the light to pass through the slide 30 unimpeded. Thus, a portion of the light undergoes total-internal reflection, while another portion of the light is passed through the slide 30 substantially unchanged.

FIG. 5 shows a detailed view of a fourth embodiment of the slide 30 of the light projection device 10 from FIG. 1. In the fourth embodiment, the slide structural elements 32-38 have a triangular shape in cross section at least in part. Some of the incident light 50 initially undergoes total-internal reflection, is subsequently refracted and then steered to the side such that the light does not reach the projection optics unit 60. Thus, in the event of appropriate angling of the slide structural elements 32-38, light that has been subject to total-internal reflection can also emerge from the slide 30 in the direction of the projection optics unit 60 and can be steered laterally past the entrance aperture of the projection optics unit 60. In regions of the slide 30 that have no triangular shape in cross section, the incident light 50 passes through the slide 30 substantially unimpeded and with no change in direction. This light is then the used light 52, 53, 54.

FIG. 6 shows a detailed view of a fifth embodiment of the slide 30 of the light projection device 10 from FIG. 1. The slide structural elements 32-38 in the fifth embodiment have a lens-like structure. As a result, the light is redistributed or deflected and/or diffracted in such a way that a kind of point array or another intermediate image, at whose points the light is focused, is generated on a plane which is spaced from the slide 30, and this point array is projected onto the surface 98 of the material 97 by means of the projection optics unit 60. No portion of the light is deflected, refracted, diffracted, or the like, in such a way that it does not contribute to generating the pattern. An advantage thereof is that all of the light is used to generate the pattern. The pattern can be particularly high in contrast as a result. The pattern radiated onto the surface 98 of the material 97 is only generated by the projection optics unit 60.

FIG. 7 shows a detailed view of a sixth embodiment of the slide 30 of the light projection device 10 from FIG. 1. The slide 30 comprises a Fabry-Perot resonator, or the slide structure elements 32-38 form Fabry-Perot resonator structures. As a result, the light is reflected substantially completely in one region (left and right of the center in FIG. 6). In the center, the light is allowed to pass through the slide 30 substantially unchanged.

FIG. 8 shows a detailed view of a seventh embodiment of the slide 30 of the light projection device 10 from FIG. 1. In the seventh embodiment, the slide structural elements 32-38 form a grating that diffracts the light. In FIG. 7, the grating formed is visible above and below the center. As a result, the light is diffracted (orders of diffraction #0) in such a way that the light either does not reach the projection optics unit 60 at all or does not contribute to the generation of the pattern after passing through the projection optics unit 60. The deflected light is shown in FIG. 7 by arrows extending diagonally upward to the right or downward to the right. The arrow extending horizontally to the right in the upper part of FIG. 7 shows the light that generates or projects the pattern.

FIG. 9 shows a detailed view of an eighth embodiment of the slide 30 of the light projection device 10 from FIG. 1. In the production of the eighth embodiment of the slide 30, slide structural elements 32-38 that absorb and/or significantly scatter the light are also produced during the additive manufacturing method. Hence, some of the light or the light in the intended areas of the slide 30 is absorbed and does not reach the projection optics unit 60. Another portion of the light is allowed to pass through the slide 30 substantially unchanged.

FIG. 10 shows a detailed view of a ninth embodiment of the slide 30 of the light projection device 10 from FIG. 1. In the ninth embodiment, there are regions of the slide 30 or the slide structural elements 32-38 that have a receptacle space. Material that partly or completely absorbs the light may be introduced into this receptacle space or these receptacle spaces during the additive manufacture of the slide 30 (and hence of the projection optics unit 60 as well). It is also conceivable that the material that partly or completely absorbs the light is introduced into the receptacle space or the receptacle spaces after the additive manufacture of the slide 30 and the projection optics unit 60. In particular, the material may be a fluid, preferably a liquid. This liquid may also be curable and e.g. polymerize or dry. It may be possible to close the receptacle spaces such that they are sealed permanently or so as to be capable of being reopened after the material has been introduced.

It is possible that the slide 30 or the optics device 20 generates a black-and-white pattern. However, it is also conceivable that the slide 30 or the optics device 20 generates a pattern which, in addition to black and white, comprises one or more gray tones. To this end, the light is only partially absorbed and/or refracted and/or reflected and/or scattered.

The slide 30 can be designed such that different regions of the slide 30 have different transmissivities for different wavelengths of light or for light of different colors or refract, diffract, reflect and/or absorb the light differently depending on the wavelength. This allows a different pattern to be projected using light of a first wavelength (e.g. blue light) than using light of a second wavelength (e.g. red light). This is possible in all the above-described embodiments of the slide 30. Thus, different patterns can be radiated at the surface 98 in temporal succession by changing the light.

It is also conceivable that the optics device 20 projects colored patterns when white light 50 is radiated into the optics device 20.

### LIST OF REFERENCE SIGNS:

10 Light projection device
20 Optics device
30 Slide
32-38 Slide structural element
52, 53, 54 Used light
55-59 Extraneous light
60 Projection optics unit
62 First lens
64 Second lens
70 First connecting pieces
80 Second connecting pieces
90 Optical fiber
95 Output surface of the light source
97 Material
98 Surface of the material

1. An optics device for projecting a pattern onto a surface, the optics device comprising:
a slide, the slide refracting and/or diffracting and/or reflecting and/or absorbing some of the light radiated into the optics device in order to generate the pattern, and
a projection optics unit, the projection optics unit being designed to image the pattern onto the surface,
wherein
the slide and the projection optics unit are formed in one piece.

2. The optics device as claimed in claim 1, wherein
the slide is designed such that the slide is substantially completely transmissive to the light directed at the slide.

3. The optics device as claimed in claim 1, wherein
the slide and the projection optics unit are made of substantially the same material,

4. The optics device as claimed in claim 1, wherein the slide is designed in such a way that some the light directed at the slide is refracted and/or diffracted and/or reflected by the slide in such a way that the refracted and/or diffracted and/or reflected portion of the light radiation is not incident on the projection optics unit.

5. The optics device as claimed in claim 1, wherein the projection optics unit comprises two lenses that are spaced apart from each other.

6. The optics device as claimed in claim 1, wherein the slide and the projection optics unit are connected, to each other by multiple first connecting pieces, with the multiple first connecting pieces being formed in one piece with the slide and the projection optics unit.

7. The optics device as claimed in claim 1, wherein the slide is designed such that at least a first region of the slide refracts and/or diffracts and/or reflects and/or absorbs light of different wavelengths differently.

8. The optics device as claimed in claim 1, wherein the slide is designed such that the projected pattern has at least one region with a gray tone when the optics device is irradiated by white light.

9. A light projection device, comprising:
an optics device as claimed in claim 1, and a light source for transmitting light into the optics device,
wherein the optics device is arranged on the light source in such a way that due to refraction and/or diffraction and/or reflection and/or absorption in the slide, only some of the light emitted by the light source forms the pattern projected by the optics device.

10. The light projection device as claimed in claim 9, wherein the optics device is arranged on the light source in such a way that due to refraction and/or diffraction and/or reflection and/or absorption in the slide, only some of the light emitted by the light source passes through the optics device.

11. The light projection device as claimed in claim 9,
wherein the light source comprises an optical fiber, a waveguide and/or an LED.

12. The light projection device as claimed in claim 9, wherein the light source is formed in one piece with the optics device.

13. The light projection device as claimed in claim 9, wherein the light source is designed in such a way that the light source radiates light onto the optics device in a conical shape, with an opening angle of no more than 30°,

14. A method for producing an optics device in an additive manufacturing method, the method comprising the producing
a slide, the slide refracting and/or diffracting and/or reflecting and/or absorbing some of the light radiated into the optics device in order to generate a pattern on a surface,
and
a projection optics unit, the projection optics unit being designed to image the pattern onto a surface, wherein the slide and the projection optics unit are produced in one piece.

15. The method as claimed in claim 14, wherein the optics device is produced additively directly on a light source for radiating light into the optics device.

16. The method as claimed in claim 14, wherein the slide is produced in such a way that only some of the light radiated into the optics device reaches the projection optics unit.

17. A method for examining a surface, wherein the method comprising:
radiating light through an optics device as claimed in claim 1 in order to generate a pattern on the surface;
capturing the light reflected from the surface; and
comparing the reflected light with a target pattern, in order to determine properties, of the surface.
